(19) United States
(12) Patent Application Publication
(10) Pub. No.: US 2025/0020943 A1
(43) Pub. Date: Jan. 16, 2025

(54) PAIR OF SPECTACLES, ASSEMBLY OF SPECTACLES TEMPLE AND ENDPIECE, AND SPECTACLES HINGE

(71) Applicant: WENZHOU WEILAN OPTICAL CO., LTD., Wenzhou. Zhejiang (CN)

(72) Inventors: Yufeng YANG, Wenzhou, Zhejiang (CN); Xindong JIANG, Wenzhou, Zhejiang (CN)

(21) Appl. No.: 18/274,882

(22) PCT Filed: Dec. 27, 2022
(86) PCT No.: PCT/CN2022/142441

§ 371 Date: Jul. 28, 2023

(30) Foreign Application Priority Data
Sep. 30, 2022 (CN) 202211214453.5

(51) Int. Cl. G02C 5/22

(52) U.S. Cl. CPC G02C 5/2227; G02C 5/2263; G02C 2200/26

(57) ABSTRACT

The present application provides a pair of spectacles, an assembly of a spectacles temple and an endpiece, and a spectacles hinge. The guide member (30) is provided with a first guide groove (31) and a second guide groove (32) that are vertically intersected, the first connecting portion (11) and the second connecting portion (21) are respectively extended into the first guide groove (31) and the second guide groove (32) and hinged in the guide member (30), so as to realize that the spectacles hinge (100) can rotate in two mutually perpendicular directions; the bottom surface of the first guide groove (31) on the guide member (30) is provided with a first inclined surface (351), such that the first connecting member (10) can be rotated between the open position and the closed position without jamming.

The present application claimed priority of a Chinese patent application, with application No. 202211214453.5, filed on Sep., 30 2022, titled “a pair of spectacles, an assembly of a spectacles temple and an endpiece, and a spectacles hinge”, submitted to CNIPA, the whole content of which is incorporated herein by reference.

### TECHNICAL FIELD

The present application relates to technical field of spectacles, and more particularly to a pair of spectacles, an assembly of a spectacles temple and an endpiece, and a spectacles hinge.

### BACKGROUND

The statements herein only provide background information related to the present application and do not necessarily constitute prior art. A pair of spectacles, including a lens frame and spectacles temples, the spectacles temples are usually hinged to the lens frame with spectacles hinges, so that the spectacles temples can be rotated between a closed position and an open position. When the spectacles temples are in the closed position, the spectacles temples are folded to the lens frame of the spectacles frame. When the spectacles temples are in the open position, the spectacles temples are generally at right angles to the lens frame, so as to adapt to the face profile of user. When spectacles are in use, the spectacles temples extend forward and backward and hang on the human ears, so that the rotation of the spectacles temples between the closed position and the open position can be regarded as rotating around the vertical axis on a horizontal plane. When people take off or put on the spectacles, the most common accidental bending is to excessively open the spectacles temples from the open position. If the spectacles temples are allowed to excessively open at a large angle, and then return to normal use, it can effectively avoid the irreversible deformation of the spectacles frame and extend the service life of the spectacles frame. Secondly, the spectacles temples are subjected to the load in the direction perpendicular to the above horizontal plane to occur accidental bending, that is, the load is applied to the spectacles temples in the up-and-down direction. If the spectacles temples are allowed to pivot and swing in the up-and-down direction, and then return to the normal use state, which can effectively prevent the spectacles frame from producing irreversible bad deformation, and extend the service life of the spectacles frame.

The spectacles temples of the existing spectacles are often folded and rotated with an elastic structure. That is, when the spectacles temples are rotated between the closed position and the open position, the spectacles temples automatically return to the closed position or the open position elastically under the elastic force of the elastic structure, which will bring better use experience to the spectacles users.

US patent application U.S. Ser. No. 10/365,501B2 and WIPO application WO/2021/114228A1 disclosed a spectacles hinge for a pair of spectacles, which includes a guide body, and two opposite end surfaces of the guide body are respectively provided with guide grooves, the two guide grooves are perpendicular to each other in a length direction, and two connectors are arranged, which are respectively extended into the two guide grooves and hinged in the guide body, and the two connectors can be pivoted to each other and swing in the corresponding guide groove. Since the length directions of the two guide grooves are perpendicular to each other, the swing directions of the two connectors are perpendicular to each other. In order to achieve elastic restoring, the two connectors are respectively equipped with springs and end elements, and the two end elements are respectively connected with the endpiece and the spectacles temples of the spectacles frame. When the spectacles temples are in the open position, the end surface of the endpiece end element in the two end elements is abutted against one end surface of the guide body, and the end surface of the end element of the spectacles temple is abutted against the other end surface of the guide body. The spectacles hinge is used in the spectacles frame, and the spectacles temples can realize multi-directional rotation, including excessive opening of large angle in the horizontal direction and large angle rotation in the up-and-down direction, and can restore the spectacles temples to the open position or closed position under the elastic force.

However, an obvious drawback of such product is that when the spectacles temples are rotated outward due to excessive opening in the horizontal direction, the guide body rotates relative to the endpiece end element, and the end surface of the endpiece end element rotates and rubs tightly against the outer side of the guide body under the elastic force. As a spectacles product, the surface of the guide body will have a surface treatment layer such as electroplated coating. After the spectacles temples are excessively opened and rotated outward for many times, The surface treatment layer on the outer side of the guide body will be worn due to friction. Because this is the rotation of the spectacles temples in the horizontal direction, it is the common rotation of the spectacles temples, which aggravates the wear of the surface treatment layer on the outer side of the guide body and damages the product quality.

A Chinese patent application CN111796435A also discloses a hinge for spectacles. The technology disclosed in the document also has the above important shortcomings. Specifically, in the technical solution of the CN111796435A, as shown in FIG. 36, the part called the central member 2 is equivalent to the guide body described in the aforementioned U.S. patent application U.S. Ser. No. 10/365,501B2. When the spectacles temples are excessive opened and rotated outward in the rotation direction between the closed position and the open position, the arc transition end surface C of the central member 2 is abutted against the adaptive platform 7 of the connector of the spectacles temple and occurred rotational friction, after the spectacles temples rotate outward from the open position for many times, the surface treatment layer on the central member 2, including the arc transition end surface C on the outer side surface, will be worn due to friction. Similarly, this occurred in the common rotation of the spectacles temples, which aggravated the wear of the surface treatment layer on the outer side surface of the central member and damaged the product quality.

Another obvious drawback of the technology disclosed in the above-mentioned U.S. Ser. No. 10/365,501B2, WO/2021/114228A1 and CN111796435A is the large size of the hinge. People usually want spectacles to be light, which requires that the cross-sectional size of hinge should not be larger. In the technical solution of the CN111796435A, as shown in FIG. 36, the adaptive platform 7 of the connector of the spectacles temple is abutted against the lower end surface of the central member 2. When the spectacles temple rotates outward due to excessive opening in the rotation direction between the closed position and the open position, from the action line of the central member 2 under the action force of the spring to the fulcrum where the initial relative rotation occurs, a force arm size is required, and the size cannot be too small, the smaller size makes the spectacles temples too easy to rotate in the direction of excessive opening outward, and the spectacles temples cannot be effectively worn on the ears of the wearer. When the spectacles temple rotates outward at a large angle, for example, when it opens outward excessively and is close to 90 degrees from the preset open position, in order to achieve elastic restoring to the preset open position, the arc transition end surface C on the lower end surface of the central member 2 needs to have a larger width dimension in the cross section direction of the hinge. That is, it is necessary to increase the size of the central member along the length direction of the B guide groove. It is not allowed to add the smaller arm size and the larger width size of the arc transition end surface C, which results in the larger size of the cross section of the hinge.

### Technical Problem

One of the objects of embodiments of the present application is to provide a pair of spectacles, an assembly of a spectacles temple and an endpiece, and a spectacles hinge to solve the problem that the outer layer of the guide member will be worn, when the guide member of the spectacles hinge rotates between the open position and the closed position, as well as between the open position and the excessive open state.

### SUMMARY

The technical solutions adopted in the embodiments of the present application are obvious drawback:

In a first aspect, a spectacles hinge is provided, which includes: a guide member, provided with a first end surface and a second end surface arranged to be opposite to each other, wherein the first end surface is provided with a first guide groove, the second end surface is provided with a second guide groove, the first guide groove is vertically intersected with the second guide groove, and the second guide groove divides a bottom surface of the first guide groove into a first divided surface and a second divided surface; a first connecting member, including a first connecting portion and a fixing portion connected with the first connecting portion; a second connecting member, including a second connecting portion, a supporting portion connected with the second connecting portion, and a stop portion arranged on the supporting portion; an abutting member, provided with a supporting surface for abutting against the guide member, the abutting member is provided with a through cavity configured to be movably penetrated by the second connecting portion; and a spring, provided with two ends are elastically abutted against the abutting member and the stop portion respectively;
the first connecting portion and the second connecting portion are hinged in the guide member and are mutually rotating pivots; the first connecting portion is able to pivot along the first guide groove and the second connecting portion is able to pivot along the second guide groove;
the first divided surface includes a first inclined surface, and the first inclined surface is inclined and extended from an end of the first inclined surface away from the second divided surface to an end of the first inclined surface close to the second divided surface in a direction towards the second end surface; and
the first connecting portion is provided with: a first positioning surface, configured to be adapted to support the first inclined surface to position the first connecting portion at an open position; a second positioning surface, configured to be adapted to support the first inclined surface to position the first connecting portion at a closed position; and a third positioning surface, configured to be abutted against the second divided surface when the first connecting portion is positioned at the open position.

In a second aspect, an assembly of a spectacles temple and an endpiece is provided, which includes the spectacles temple, the endpiece, and the spectacles hinge mentioned above, the fixing portion is connected with one of the spectacles temple and the endpiece, and the abutting member is connected with the other one of the spectacles temple and the endpiece.

In a third aspect, a pair of spectacles is provided, which includes a lens frame and spectacles temples, and further includes the spectacles hinge mentioned above, to hinge the spectacles temples to the lens frame.

### Beneficial Effects

On the one hand, in the spectacles hinge provided by embodiments of the present application, since the first divided surface of the first guide groove of the guide member is provided with the first inclined surface, and the first inclined surface is inclined and extended from an end of the first inclined surface away from the second divided surface to an end of the first inclined surface close to the second divided surface in a direction towards the second end surface, and accordingly, the first positioning surface is provided at the first connecting portion to abut against the first inclined surface, and the first connecting portion is positioned at the open position, the second positioning surface is arranged to abut against the first inclined surface, the first connecting portion is positioned at the closed position, and the third positioning surface is arranged to abut against the second divided surface when the first connecting portion is arranged at the open position. With the above arrangements, the rotation of the spectacles hinge between the open position and the closed position is carried out by sliding of the first smooth transition surface formed between the first positioning surface and the second positioning surface on the first inclined surface. Therefore, the rotation between the open position and the closed position that the spectacles hinge have the elastic returned function is realized by the first connecting portion abutting against the first inclined surface in the guide member; which makes the rotation of the spectacles hinge between the open position and the closed position, as well as between the open position and the excessive open state, without wearing the outer layer of the guide member.

On the other hand, since the first divided surface of the first guide groove of the guide member is provided with the first inclined surface, the first inclined surface is inclined and extended from an end of the first inclined surface away from the second divided surface to an end of the first inclined surface close to the second divided surface in a direction towards the second end surface; thus, the thickness of the portion of the bottom portion of the first guide groove corresponding to the first divided surface is gradually decreased from the direction from one end away from the second divided surface to the second guide groove, so that the thickness of the end of the bottom portion of the first guide groove away from the second divided surface is larger, so as to ensure the strength of the bottom structure of the first guide groove and reduce the size of the guide member along the length direction of the first guide groove. The thickness of the position at the bottom portion of the first guide groove close to the second guide groove is smaller, so that the distance between the hinge of the first connecting portion and the second connecting portion and the second end surface is smaller. When the second connecting portion rotates at a large angle close to 90 degrees to the first connecting portion, the torque formed between the guide member and the supporting surface through the elastic force of the spring on the guide member through the second connecting portion is greater, thus, when the torque is guaranteed to be constant, the size of the guide member along the length direction of the second guide groove is smaller, thus the size of the guide member is reduced, and thus the size and weight of the spectacles hinge are reduced. When applied to spectacles, the wearing experience of spectacles can be guaranteed.

### BRIEF DESCRIPTION OF THE DRAWINGS

In order to more clearly explain the technical solution in the embodiments of the present application, the following will briefly introduce the drawings needed in the embodiments or the exemplary technical description. It is obvious that the drawings in the following description are only some embodiments of the present application. For those skilled in the art, other drawings can also be obtained from these drawings without creative work.

FIG. 1 is the structural schematic view of a spectacles hinge provided in Embodiment 1 of the present application;

FIG. 2 is an explosive schematic view of a spectacles hinge provided in Embodiment 1 of the present application;

FIG. 3 is a schematic view of a top structure of a spectacles hinge provided in Embodiment 1 of the present application;

FIG. 4 is a sectional schematic view along a A-A line in FIG. 3;

FIG. 5 is a sectional schematic view along a B-B line in FIG. 3;

FIG. 6 is a sectional schematic view of a second connecting member in FIG. 5 after the second connecting member rotates 90 degrees;

FIG. 7 is a structural schematic view 1 of a guide member provided in Embodiment 1 of the present application;

FIG. 8 is a structural schematic view 2 of a guide member provided in Embodiment 1 of the present application;

FIG. 9 is a sectional schematic view along a C-C line in FIG. 8;

FIG. 10 is a structural schematic view of a first connecting member provided in Embodiment 1 of the present application;

FIG. 11 is a sectional schematic view of a first connecting member provided in Embodiment 1 of the present application when it is in an open position on a guide member;

FIG. 12 is a sectional schematic view 1 of the first connecting member in FIG. 11 when it is arranged between the open position and the closed position on the guide member;

FIG. 13 is a sectional schematic view 2 of the first connecting member in FIG. 11 when it is arranged between the open position and the closed position on the guide member;

FIG. 14 is a sectional schematic view 3 of the first connecting member in FIG. 11 when it is arranged between the open position and the closed position on the guide member;

FIG. 15 is a sectional schematic view of a first connecting member provided in Embodiment 1 of the present application when it is in a closed position on a guide member;

FIG. 16 is a sectional schematic view 1 of the first connecting member rotating from the closed position to the open position in FIG. 15;

FIG. 17 is a sectional schematic view 2 of the first connecting member rotating from the closed position to the open position in FIG. 15;

FIG. 18 is the sectional schematic view of a first connecting member in FIG. 11 when it is in an excessive opened position on the guide member;

FIG. 19 is a sectional schematic view of a guide member provided in Embodiment 2 of the present application;

FIG. 20 is a structural schematic view of a first connecting member provided in Embodiment 2 of the present application;

FIG. 21 is a sectional schematic view of a first connecting member provided in Embodiment 2 of the present application when it is in an open position on the guide member;

FIG. 22 is the sectional schematic view of the first connecting member rotating from the open position to the closed position in FIG. 21;

FIG. 23 is a sectional schematic view of the first connecting member in FIG. 21 when it is in the closed position;

FIG. 24 is a sectional schematic view of the first connecting member rotating from the closed position to the open position in FIG. 21;

FIG. 25 is a sectional schematic view of the first connecting member in FIG. 21 when it is in the excessive open position;

FIG. 26 is a sectional schematic view of a spectacles hinge provided by a comparative technical solution related to the present application;

FIG. 27 is a sectional schematic view of the second connecting member in FIG. 26 after the second connecting member rotates 90 degrees;

FIG. 28 is a structural schematic view of a first connecting member provided by a comparative technical solution related to the present application;

FIG. 29 is a sectional schematic view of a double-groove member provided by a comparative technical solution related to the present application;

FIG. 30 is a sectional schematic view of a front connecting member in the open position on a double-groove member provided by a comparative technical solution related to the present application;

FIG. 31 is a sectional schematic view 1 of the front connecting member arranged between the open position and the closed position on the double-groove member in FIG. 30;

FIG. 32 is a sectional schematic view 2 of the front connecting member arranged between the open position and the closed position on the double-groove member in FIG. 31;

FIG. 33 is the sectional schematic view of the front connecting member in FIG. 30 when it is in the closed position on the double-groove member;

FIG. 34 is an explosive schematic view of an assembly of a spectacles temple and an endpiece provided by an embodiment of the present application;

FIG. 35 is an explosive schematic view of a pair of spectacles provided by an embodiment of the present application; and

FIG. 36 is the structural schematic view of a spectacles hinge provided in the related technology.

### DETAILED DESCRIPTION OF EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component.

In addition, terms “the first” and “the second” are only used in describe purposes, and should not be considered as indicating or implying any relative importance, or impliedly indicating the number of indicated technical features. As such, technical feature(s) restricted by “the first” or “the second” can explicitly or impliedly comprise one or more such technical feature(s). In the description of the present application, “a plurality of” means two or more, unless there is additional explicit and specific limitation.

In the description of the present application, it needs to be understood that, directions or location relationships indicated by terms such as “central”, “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

In the present application, unless there is additional explicit stipulation and limitation, terms such as “mount”, “connect with each other”, “connect”, “fix”, and so on should be generalizedly interpreted, for example, “connect” can be interpreted as being fixedly connected, detachably connected, or connected integrally; “connect” can also be interpreted as being mechanically connected or electrically connected; “connect” can be further interpreted as being directly connected or indirectly connected through intermediary, or being internal communication between two components or an interaction relationship between the two components. For the one of ordinary skill in the art, the specific meanings of the aforementioned terms in the present application can be interpreted according to specific conditions.

The reference to “one embodiment”, “some embodiments” or “embodiments” described in the specification of the present application means that one or more embodiments of the present application include specific features, structures or features described in combination with the embodiments. Therefore, the statements “in one embodiment”, “in some embodiments”, “in some other embodiments”, “in further other embodiments” and “in yet other embodiments” in the different parts of the specification do not necessarily refer to the same embodiment, but mean “one or more but not all embodiments”, unless otherwise specially emphasized in other ways. In addition, in one or more embodiments, specific features, structures or features may be combined in any suitable way.

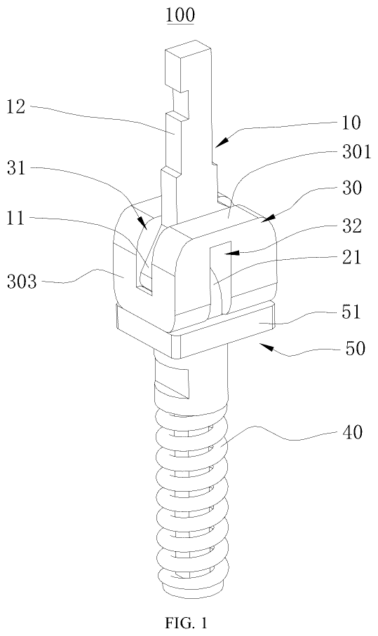

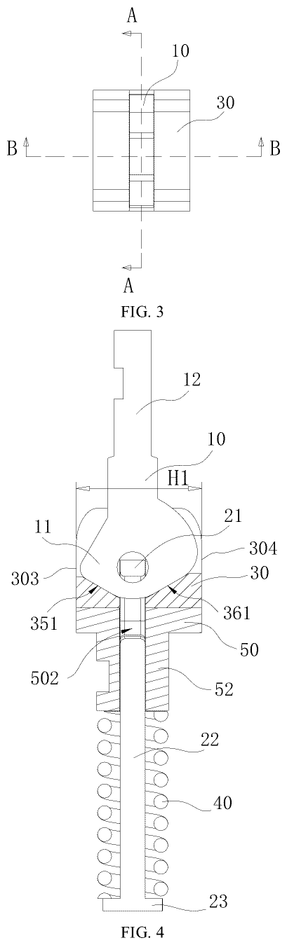

As shown in FIGS. 1 to 10, the spectacles hinge 100 provided in Embodiment 1 of the present application will be described. The spectacles hinge 100 includes a guide member 30, a first connecting member 10, a second connecting member 20, an abutting member 50, and a spring 40;

The guide member 30 is provided with a first end surface 301, a second end surface 302, a first side surface 303, a second side surface 304, a third side surface 305, and a fourth side surface 306. The first end surface 301 and the second end surface 302 are the two opposite end surfaces on the guide member 30, the first side surface 303 and the second side surface 304 are the two opposite side surfaces on the guide member 30, and the third side surface 305 and the fourth side surface 306 are the two opposite end surfaces on the guide member 30.

Corresponding to the groove structure, which generally has a depth direction, a width direction and a length direction. The direction perpendicular to the two sides of the groove structure is the width direction, the direction from the opening of the groove to the bottom of the groove is the depth direction, and the direction from one end of the groove to the other end of the groove is the length direction.

The first end surface 301 is provided with a first guide groove 31, that is, the guide member 30 is provided with the first guide groove 31. The depth direction of the first guide groove 31 extends from the first end surface 301 to the second end surface 302, and the direction from the first side surface 303 to the second side surface 304 is the length direction of the first guide groove 31.

The second end surface 302 is provided with a second guide groove 32, that is, the guide member 30 is further provided with the second guide groove 32. The depth direction of the second guide groove 32 extends from the second end surface 302 to the first end surface 301, that is, the direction from the third side 305 to the fourth side 306 is the length direction of the second guide groove 32.

The first guide groove 31 and the second guide groove 32 are intersected vertically, the first guide groove 31 and the second guide groove 32 are intersected inside the guide member 30, and the length direction of the first guide groove 31 is perpendicular to the length direction of the second guide groove 32, so the second guide groove 32 divides the bottom surface of the first guide groove 31 into two sub-bottom surfaces, namely the first divided surface 35 and the second divided surface 36. Accordingly, the second guide groove 32 divides the bottom of the first guide groove 31 into two sub-bottoms, namely the first sub-bottom 37 and the second sub-bottom 38. The first divided surface 35 is located on the first sub-bottom 37, and the second divided surface 36 is located on the second sub-bottom 38.

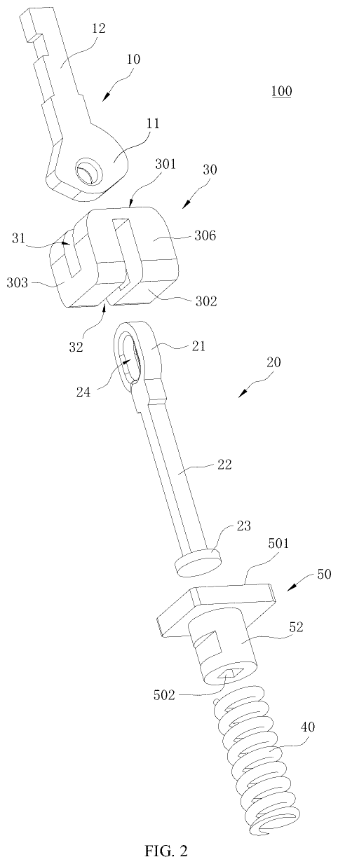

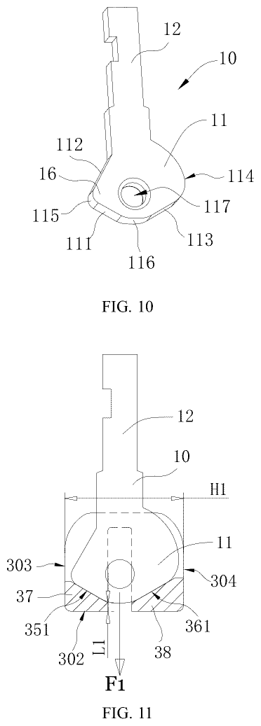

As shown in FIG. 1, FIG. 2, FIG. 4 and FIG. 10, the first connecting member 10 includes the first connecting portion 11 and the fixing portion 12. The first connecting portion 11 is connected with the fixing portion 12, the first connecting portion 11 extends into the first guide groove 31, and the fixing portion 12 extends out of the first guide groove 31. The fixing portion 12 drives the first connecting portion 11 to rotate along the first guide groove 31.

As shown in FIG. 1, FIG. 2, FIG. 4 and FIG. 5, the second connecting member 20 includes the second connecting portion 21, the supporting portion 22 and, the stop portion 23. The supporting portion 22 is connected with the second connecting portion 21, and the stop portion 23 is connected with the supporting portion 22. The second connecting portion 21 extends into the second guide groove 32, while the supporting portion 22 and the stop portion 23 extend out of the second guide groove 32. The supporting portion 22 drives the second connecting portion 21 to rotate along the second guide groove 32.

The first connecting portion 11 and the second connecting portion 21 are hinged in the guide member 30 and are mutually rotating pivots. The first connecting portion 11 can pivot along the first guide groove 31, and the second connecting portion 21 can pivot along the second guide groove 32.

In the embodiment, the first connecting portion 11 is provided with a first hinge hole 117, and the second connecting portion 21 is provided with a second hinge hole 24 to hinge the first connecting portion 11 with the second connecting portion 21. In the embodiment, the second hinge hole 24 is an oval or oblong hinge hole. In other embodiments, the second connecting portion 21 can also be arranged in a hook shape to hinge the first connecting portion 11 with the second connecting portion 21.

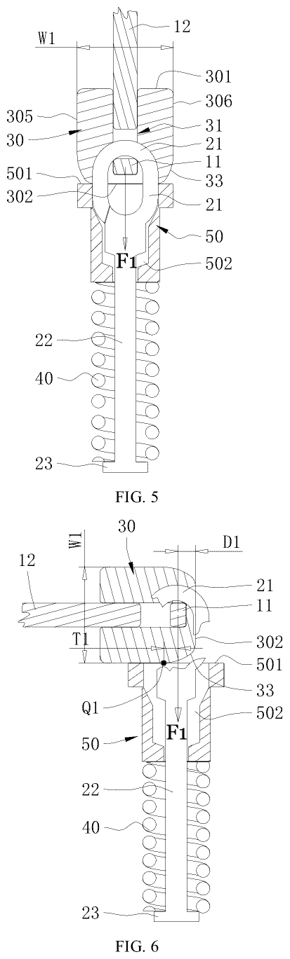

As shown in FIG. 1, FIG. 2, FIG. 4 and FIG. 6, the abutting member 50 and the supporting portion 22 are mounted slidably relative to each other, and the abutting member 50 is used to support the guide member 30. For example, the supporting surface 501 is arranged on the abutting member 50, and the abutting member 50 is provided with a through cavity 502 configured to be movably penetrated by the second connecting portion; when in use, the supporting portion 22 of the second connecting member 20 is arranged passing through the through cavity 502, and the second connecting portion 21 extends out of the butting surface 501 of the abutting member 50 from the through cavity 502. The spring 40 is sleeved on the supporting portion 22, and the two ends of the spring 40 are elastically abutted against the stop portion 23 and the abutting member 50 respectively, so that under the elastic force of the spring 40 the abutting member 50 can slide along the supporting portion 22; since the second connecting portion 21 is hinged with the first connecting portion 11, the second connecting portion 21 elastically pulls the first connecting portion 11 in the length direction of the supporting portion 22, that is, a force towards the direction of the supporting portion 22 is applied to the first connecting portion 11 such that the first connecting portion 11 is elastically abutted against the bottom of the first guide groove 31. Therefore, under the elastic force of the spring 40, the supporting surface 501 of the abutting member 50 is abutted against the guide member 30. For the convenience of description, the force of spring 40 applied on the first connecting portion 11 is called the force of spring 40.

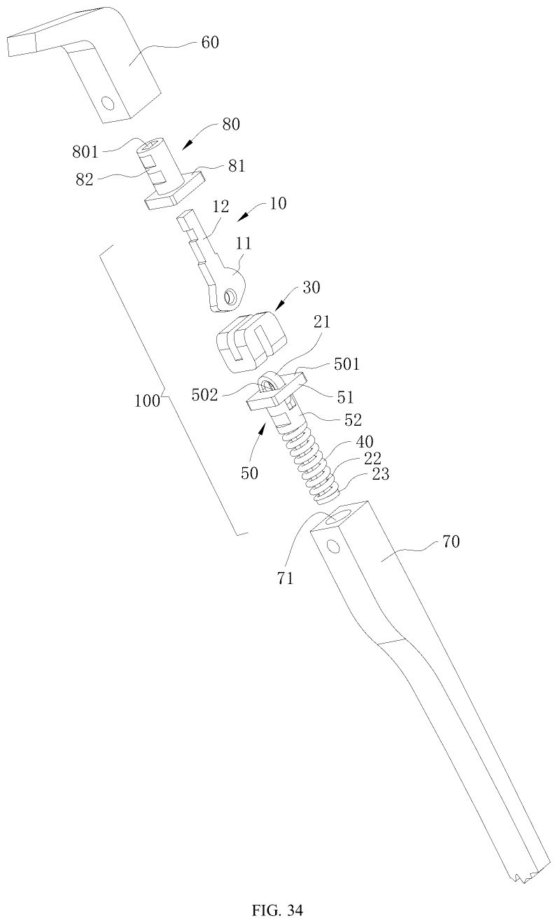

Further in combination with FIG. 34, when the spectacles hinge 100 is in use, the first connecting member 10 is connected with one of the endpiece 60 and the spectacles temples 70, and the abutting member 50 is connected with the other one of the endpiece 60 and the spectacles temples 70, so as to realize that the spectacles hinge 100 is connected with the endpiece 60 and the spectacles temples 70 of the spectacles frame. When the spectacles temples 70 are approximately perpendicular to the lens frame of the spectacles frame, the spectacles temples 70 are in the open state. At this time, the length direction of the first connecting member 10 is consistent with the depth direction of the first guide groove 31, and the position of the first connecting member 10 at this time can be regarded as the open position. When the spectacles temples 70 are folded on the lens frame of the spectacles frame, the spectacles temples 70 are in the closed state. At this time, the length direction of the first connecting member 10 is generally the same as the length direction of the first guide groove 31, therefore, the position of the first connecting member 10 at this time can be regarded as the closed position. The first connecting member 10 rotates from the closed position to the open position in the first guide groove 31 and exceeds the open position, that is, the first connecting member 10 rotates to the side of the open position away from the closed position, and the position of the first connecting member 10 at this time can be regarded as the excessive open position.

The first divided surface 35 includes a first inclined surface 351, which is inclined and extended from an end of the first inclined surface 35 away from the second divided surface 36 to an end of the first inclined surface 35 close to the second divided surface 36 in a direction towards the second end surface 302. The first inclined surface 351 is a flat surface or an arc surface, or a combination of a flat surface and an arc surface.

As shown in FIG. 4, FIG. 9, FIG. 10, FIG. 11 and FIG. 13, the first connecting portion 11 is provided with a first positioning surface 111, a second positioning surface 112, and a third positioning surface 113. The first positioning surface 111 is abutted against the first inclined surface 351 of the first divided surface 35. When the first positioning surface 111 is abutted against the first inclined surface 351, the first connecting portion 11 can be positioned in the open position, that is, the first connecting member 10 can be positioned in the open position. The second positioning surface 112 is also abutted against the first inclined surface 351. When the second positioning surface 112 is abutted against the first inclined surface 351, the first connecting portion 11 can be positioned in the closed position, that is, the first connecting member 10 can be positioned in the closed position. The third positioning surface 113 is used to abut against the second divided surface 36 when the first connecting portion is positioned at the open position. The first positioning surface 111 supports the first divided surface 35, and the third positioning surface 113 supports the second divided surface 36, which can stably position the first connecting member 10 in the open position.

In one embodiment, the first connecting portion 11 is provided with a guide surface 114. When the first connecting member 10 rotates to the excessive open position, as shown in FIG. 18, the guide surface 114 abuts against the second divided surface 36. At this time, since the first connecting portion 11 is under the force of the spring 40, the guide surface 114 guides the first connecting portion 11 to the open position, so that the first connecting member 10 returns to the open position.

A first smooth transition surface 115 is arranged between the first positioning surface 111 and the second positioning surface 112, that is, the first connecting portion 11 is provided with a convex portion 16 arranged between the second positioning surface 12 and the second positioning surface 14, and the outer end surface of the convex portion 16 is the first smooth transition surface 115. When the first connecting portion 11 rotates between the open position and the closed position, the first smooth transition surface 115 supports and slides on the first inclined surface, so that the first connecting member 10 can rotate smoothly.

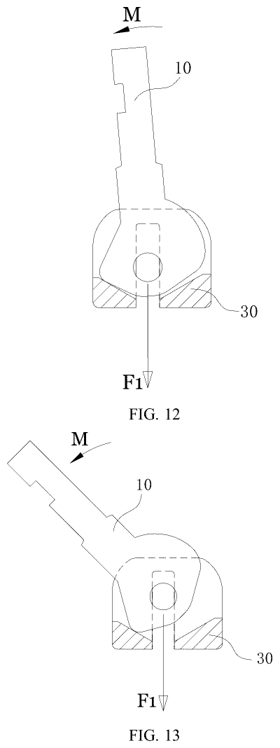

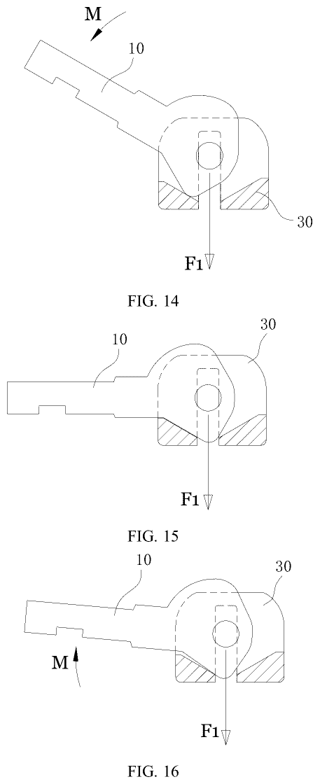

In one embodiment, as shown in FIGS. 11 to 17, the first connecting portion 11 is limited to rotate in the first guide groove 31, the first connecting portion 11 pivots relative to the second connecting portion 21 hinged with the first connecting portion 11, and the first connecting portion 11 is subject to the force of the spring 40 shown by the arrow F1 of the second connecting portion 21. The first connecting member 10 shown in FIG. 11 is in the open position, the first connecting member 10 shown in FIG. 12 is in a position that initially rotates 5 degrees in the direction of the arrow M under the action of external force, then the first connecting member 10 shown in FIG. 15 is in a position that rotates 45 degrees, and then the first connecting member 10 shown in FIG. 15 is in a position that rotates 60 degrees; where the first smooth transition surface 115 of the convex portion 16 slides smoothly on the first inclined surface 351 without jamming. Moreover, when the first connecting member 10 is rotated about 55 degrees from the open position to the closed position as shown in FIG. 14, the first connecting member 10 can automatically rotate to the closed position as shown in FIG. 15 under the force of the spring 40 in the direction of arrow F1. That is, the spectacles hinge can be smoothly rotated from the open position to the closed position without jamming, and can also be automatically returned to the closed position under the force of the spring after it has been rotated for a certain angle.

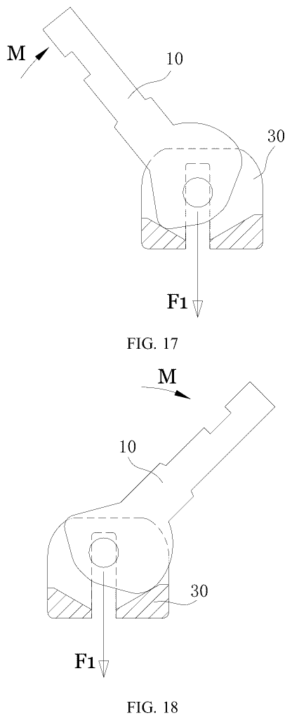

When the spectacles hinge needs to rotate from the closed position as shown in FIG. 15 to the open position, for example, rotating from the initial position to the state as shown in FIG. 16, which can also be carried out smoothly under the action of external force without jamming. Since when the first connecting member 10 shown in FIG. 15 is in the closed position, the second positioning surface 112 of the first connecting portion 11 is adapted to support the first inclined surface 351 of the guide member 30, at this time, the second positioning surface 112 is parallel to the first inclined surface 351, and no part of the convex portion 16 is in the concave portion or groove portion of the first inclined surface 351 and its extended plane, such that when the first connecting portion rotates from the closed position to the open position, the rotation is started from the initial rotation angle as shown in FIG. 16, until the outer end surface of the convex portion 16 (that is, the first smooth transition surface 115) rotates to the first inclined surface 351 for sliding, which can be smoothly carried out under the action of external forces without jamming. Then, when it continues to rotate, the first connecting portion 11 slides smoothly from the first smooth transition surface 115 on the first inclined surface 351 under the action of external force. After the first connecting portion 11 has rotated about 50 degrees, as shown in FIG. 17, under the force of spring, the spectacles hinge can automatically rotate to the open position shown in FIG. 11.

As mentioned above, the spectacles hinge in the embodiments of the present application can be smoothly rotated from the open position to the closed position, or from the closed position to the open position, without jamming; and it can be automatically returned to the closed position or open position under the force of spring after rotating a certain angle. This is one of the important and beneficial effects of the technical solution of the present application.

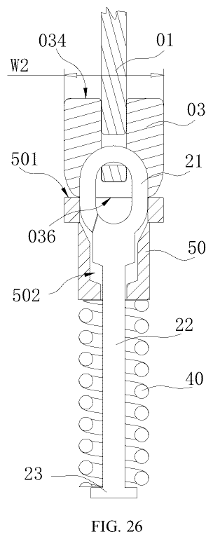

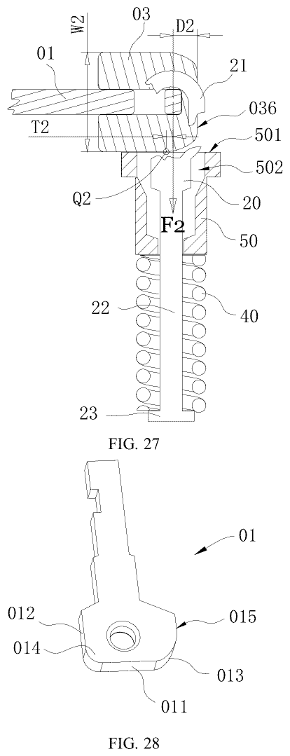

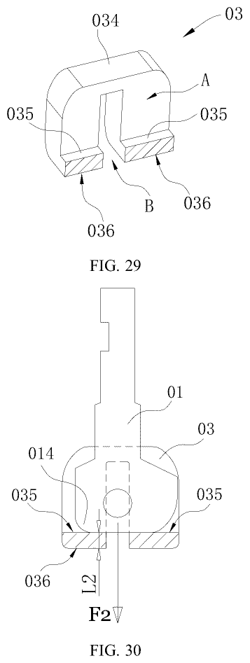

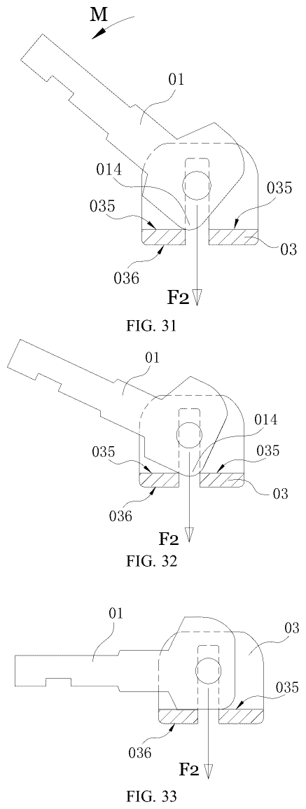

In order to better illustrate the effect of the spectacles hinge 100 in the embodiments of the present application, the following description will be made in combination with the comparative technical solution related to the present application. As refer to the spectacles hinge provided by the comparative technical solutions shown in FIGS. 26 to 33, supposing that a spectacles hinge of the comparative technical solution is similar to that of in Embodiment 1 of the present application, the difference is that the guide member 30 in Embodiment 1 of the present application is replaced by a double-groove member 03 shown in FIG. 29, and the first connecting member 10 in Embodiment 1 of the present application is replaced by a front connecting member 01 as shown in FIG. 28. The double-groove member 03 includes a front end surface 034 and a rear end surface 036, and the front end surface 034 is provided with a guide groove A, and the rear end surface 036 is provided with a guide groove B. The guide groove A and the guide groove B are perpendicular to each other. The difference between the double-groove member 03 in the comparative technical solution and the guide member 30 in the embodiment of the present application is that the bottom surface 035 of the A guide groove is divided by the B guide groove into two sub-bottom surfaces, and the two sub-bottom surfaces are parallel to the rear end surface 036, that is, the two sub-bottom surfaces of the A guide groove divided by the B guide groove are 180 degrees straight to each other. The difference between the front connecting member 01 and the first connecting member 10 of the embodiments of the present application is that when the spectacles hinge is in the open position, a front end surface 011 of a front end of the front connecting member 01 is abutted against the two sub-bottom surfaces of the bottom surface 035 of the A guide groove; and when the spectacles hinge is in the closed position, a closed side surface 011 of the front end of the front connecting member 01 is abutted against the two sub-bottom surfaces of the bottom surface 035 of the A guide groove, the closed side surface 012 and the front end surface 011 form an included angle of about 90 degrees, and the front connecting member 01 also forms a smooth transition convex portion 014 between the front end surface 011 and the closed side surface 012. as shown in FIGS. 30 to 33, when the spectacles hinge needs to rotate from the open position shown in FIG. 30 to the closed position shown in FIG. 33, for example, before reaching the state shown in FIG. 31 after rotating 30 degrees, which can be carried out under the action of external force. However, after rotating about 40 degrees to the state shown in FIG. 31, the convex portion 014 is started to slide into the concave portion formed between the two sub-bottom surfaces of the bottom surface 035 of the A guide groove under the force of the spring shown by arrow F2, and then at the position of rotating about 65 degrees, as shown in FIG. 32, both sides of the convex portion 014 fall into the concave portion between the two sub-bottom surfaces of the bottom surface 035, and at this time, the convex portion 014 is still under the force of the spring as shown by arrow F2, so the rotation is jammed and cannot be smoothly rotated to the closed position as shown in FIG. 33. In the same way, when the spectacles hinge of the comparative technical solution rotates from the closed position to the open position, it will also be jammed and cannot complete the rotation smoothly. In combination with the foregoing, the spectacles hinge in the embodiment of the present application overcomes the defects in the comparative technical solution.

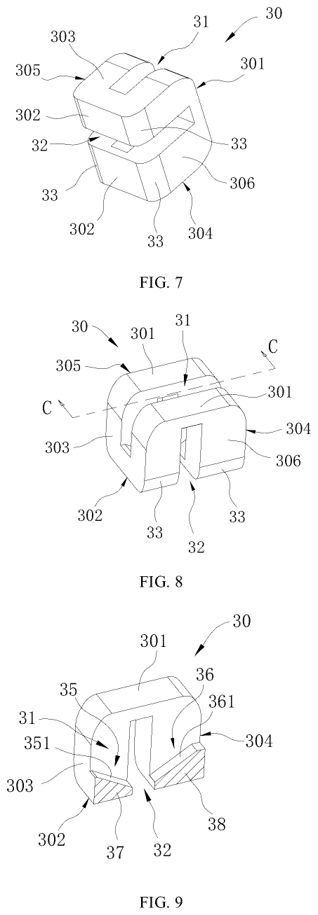

Another important aspect is that in one embodiment, as shown in FIG. 4, FIG. 5, FIG. 6, and FIG. 7. The second end surface 302 is a flat surface, the two opposite side surfaces of the guide member 30 along the length direction of the second guide groove 32 are respectively provided with a guide arc surface 33 connected to the second end surface 302, that is, the transition between the third side surface 305 and the second end surface 302 is smooth through the guide arc surface 33, and the transition between the fourth side surface 306 and the second end surface 302 is also smooth through the guide arc surface 33. In this way, when the supporting surface 501 of the abutting member 50 is adapted to support the second end surface 302, the second connecting member 20 can be positioned, which can be regarded as arrangement positioned. The guide arc surface 33 is used to guide the second connecting member 20 and the abutting member 50 to return to the arrangement positioned state when the second connecting member 20 rotates along the second guide groove 32 and drives the abutting member 50 to rotate relative to the guide member 30. When the second connecting member 20 rotates along the second guide groove 32, which drives the abutting member 50 to rotate relative to the guide member 30. At this time, the position Q1 where the guide member 30 abuts against the supporting surface 501 is located on the guide arc surface 33.

Since the supporting surface 501 on the abutting member 50 elastically supports the guide member 30, and the abutting member 50 is sleeved on the second connecting member 20, when the second connecting portion 21 of the second connecting member 20 rotates along the second guide groove 32, the abutting member 50 rotates with the second connecting member 20, and the force of the spring 40 on the first connecting portion 11 is transmitted to the guide member 30 along the direction of the supporting portion 22 through the first connecting portion 11, such that the guide arc surface 33 of the guide member 30 abuts against the supporting surface 501 of the abutting member 50. When the abutting member 50 rotates with the second connecting member 20 relative to the guide member 30, the position Q1 where the supporting surface 501 abuts against the guide member 30 is changed. With the increase of the rotation angle, the position Q1 where the supporting surface 501 abuts against the guide member 30 will deviate from the line where the force F1 is located in an increasing distance, which will form a restoring force arm. Thus, the second connecting member 20 and the abutting member 50 are automatically returned.

As shown in FIGS. 4 to 9, since the first divided surface 35 includes the first inclined surface 351, the first inclined surface 351 is inclined and extended from an end of the first inclined surface 351 away from the second divided surface 36 to an end of the first inclined surface 351 close to the second divided surface 36 in a direction towards the second end surface 302; that is, the distance from the first inclined surface 351 to the second end surface 302 gradually decreases from the direction from the first side surface 303 to the second guide groove 32, the distance from the first divided surface 35 to the second end surface 302 is the thickness of the first sub-bottom 37, and the thickness of the first sub-bottom 37 gradually decreases along the direction of the first inclined surface 351 from the first side surface 303 to the second guide groove 32, so that the thickness of the first sub-bottom 351 close to the first side surface 303 is larger, to ensure the structural strength of the first sub-bottom 351, and thus the structural strength of the bottom of the first guide groove 31 is ensured. In this way, the size H1 of the guide member 30 along the length direction of the first guide groove 31 is smaller, that is, the distance between the first side surface 303 and the second side surface 304 is smaller to reduce the size of the guide member 30.

In addition, the thickness of the first sub-bottom 351 gradually decreases from the direction from the first side surface 303 to the second guide groove 32, while the thickness of the first sub-bottom 37 close to the first side surface 303 is larger, that is, while ensuring the structural strength of the first sub-bottom 35, the distance from the end of the first divided surface 35close to the second guide groove 32 to the second end surface 302 is smaller, such that the hinge of the first connecting portion 11 with the second connecting portion 21 is closer to the second end surface 302, so as to serve as the pivot of the second connecting member 20, that is, the hinge of the first connecting portion 11 with the second connecting portion 21 is closer to the second end surface 302. Since when the second connecting member 20 drives the abutting member 50 to rotate, the force of spring 40 is always along the length direction of the supporting portion 22, and the position Q1 where the supporting surface 501 of the abutting member 50 abuts against the guide member 30 is the pivot point of the rotation of the guide member 30 relative to the second connecting member 20. When the second connecting member 20 rotates 90 degrees, the distance T1 between the position Q1 where the supporting surface 501 abuts against the guide member 30 and the force line of force F1 of the spring 40 reaches the maximum. However, when the hinge between the first connecting portion 11 and the second connecting portion 21 is closer to the second end surface 302, and when the size W1 of the guide member 30 along the length direction of the second guide groove 32 is constant, the distance between the position Q1 where the supporting surface 501 abuts against the guide member 30 and the force line of force F1 of the spring 40 is greater. Therefore, it should be understood that when the torque required for the second connecting member 20 to return is constant, the distance between the position Q1 where the supporting surface 501 abuts against the guide member 30 and the force line of force F1 of the spring 40 can be smaller, and correspondingly, the size W1 of the guide member 30 along the length direction of the second guide groove 32 can be smaller. Therefore, the size of the guide member 30 can be made smaller, and the size of the spectacles hinge 100 can be reduced. When used in spectacles, the wearing experience of the user is improved.

In one embodiment, as shown in FIGS. 1, 4 and 5. The spring 40 is sleeved on the supporting portion 22 for positioning and installing the spring 40. In other embodiments, the spring 40 is supported in other ways. For example, a slot is provided on the supporting portion 22 to place the spring 40 in the slot.

In one embodiment, the first positioning surface 111 and the second positioning surface 112 are flat surfaces or curved surfaces to be adapted to support the first inclined surface 351, which is convenient to stably position the first connecting portion 11 in the open position or closed position when supporting the first inclined surface 351, and to facilitate the first connecting portion 11 to have the technical effect of without jamming as described above when pivoting along the first guide groove 31, and further have the technical effect of automatically returning to the closed position or open position under the force of spring after rotating a certain angle.

In one embodiment, the third positioning surface 113 is a flat surface or a curved surface to match with the second divided surface.

In one embodiment, the third positioning surface 113 is an arc surface smoothly connected by a plurality of circular arc surfaces, since when the first positioning surface 11I and the first inclined surface 351 are adapted to support each other, the third positioning surface supports the second divided surface, and the first connecting portion 11 can be positioned in the open position, and the third positioning surface 113 is arranged as an arc surface which is smoothly connected by a plurality of circular arc surfaces, and when the first connecting member 10 is excessively opened, such arrangement is convenient to guide the first connecting member 10 to return to the open position. It is understood that the third positioning surface 113 can also be a circular arc surface, to guide the first connecting member 10 to return to the open position when the first connecting member 10 is excessively opened.

In one embodiment, the third positioning surface 113 is a part of the guide surface 114, that is, at this time, the third positioning surface 113 is not provided, and only provided with the guide surface 114, the first connecting portion 11 is positioned at the open position by the first positioning surface 111 and the first divided surface 361 being adapted to support each other, and by the guide surface 114 and the second divided surface 36 being supported each other; when the first connecting member 10 rotates to the excessive open position, the guide surface 114 still supports the second divided surface 362, and under the force of the spring 40, the first connecting portion 11 is guided to return to the open position, so that the first connecting member 10 returns to the open position.

In one embodiment, a second smooth transition surface 116 is provided between the first positioning surface 111 and the third positioning surface 113 to avoid hindering the rotation of the first connecting portion 11 and facilitate the processing and manufacturing of the first connecting portion 11.

In one embodiment, as shown in FIGS. 4, 9 and 11, the second divided surface 36 includes a second inclined surface 361, the second inclined surface 361 is inclined and extended from an end of the second inclined surface 361 away from the first divided surface 35 to an end the second inclined surface 361 close to the first divided surface 35 in a direction towards the second end surface 302. That is, in the direction from the second side surface 304 to the second guide groove 32, the direction from the second divided surface 36 to the second end surface 302 gradually decreases, the direction from the second divided surface 36 to the second end surface 302 is the thickness of the second sub-bottom 38, that is, the thickness of the second sub-bottom 38 gradually decreases from the second side surface 304 to the second guide groove 32. Therefore, the thickness of the second sub-bottom 38 close to the second side surface 304 is larger, so as to ensure the structural strength of the second sub-bottom 38. the size H1 of the guide member 30 along the length of the first guide groove 31 can be further made smaller when combining with the first sub-bottom 37 described above, that is, the distance between the first side surface 303 and the second side surface 304 is smaller to reduce the size of the guide member 30. The second inclined surface 361 can be a flat surface or a curved surface, or a combination of a flat surface and a curved surface.

The thickness of the second sub-bottom 38 gradually decreases from the direction from the second side surface 304 to the second guide groove 32, which can be matched with the first sub-bottom 351 to form a V-shaped groove structure to better position the first connecting member 10 in the open position.

In one embodiment, the inclination of the first inclined surface 351 and the inclination of the second inclined surface 361 are symmetrical about the second guide groove 32, that is, the inclination of the first inclined surface 351 is equal to the inclination of the second inclined surface 361. In other embodiments, the inclination of the first inclined surface 351 and the inclination of the second inclined surface 361 are asymmetrical.

In order to better illustrate the effect of the spectacles hinge 100 in the embodiments of the present application, the following will be described in combination with the previously described comparative technical solution, as refer to the comparative technical solutions shown in FIGS. 26 to 33. The difference between the comparative technical solution and the embodiment of the present application is that in the comparative technical solution, the bottom surface 035 of the A guide groove of the double-groove member 03 is a flat surface, and the bottom surface 035 of the A guide groove is divided by the B guide groove into two sub-bottom portions, and the thicknesses of the two sub-bottom portions are equal. In this way, when the spectacles hinge is in the open position, a front end surface 011 at the front end of the front connecting member 01 is abutted against the two sub-bottom surfaces of the bottom surface 035 of the A guide groove, so as to position the front end surface 011 in the open position; when the spectacles hinge is in the closed position, a closed side surface 012 at the front end of the front connecting member 01 is abutted against the two sub-bottom surfaces of the bottom surface 035. When the front connecting member 01 rotates between the open position and the closed position, the outer edge of the convex portion 014 formed between the front end surface 011 and the closed side surface 012 is supported on the bottom surface 035.

In the embodiment of the present application, the thickness of the first sub-bottom portion 351 close to the end of the second guide groove 32 is L1. In the comparative technical solution, since the thicknesses of the two sub-bottom portions of the bottom surface 035 are equal, in order to ensure the structural strength of the bottom of the A guide groove, the thickness L2 of the two sub-bottom portions of the bottom surface 035 needs to be larger, that is, L2>L1.

As shown in FIG. 6. In the embodiment of the present application, the force F1 of spring 40 is along the length direction of the supporting portion 22, the distance from the force F1 of spring 40 to the second end surface 302 is D1, and when the second connecting member 20 rotates along the second guide groove 32, the position Q1 where the guide arc surface 33 abuts against the supporting surface 501 is the pivot point of the guide member 30 relative to the second connecting member 20. When the second connecting member 20 rotates 90 degrees, the distance from the position Q1 to the force F1 of spring 40 is T1, and the size of guide member 30 along the length direction of the second guide groove 32 is W1.

As shown in FIG. 26. In the comparative technical solution, the force F2 of spring 40 is along the length direction of the supporting portion 22, and the distance between the force F2 of spring 40 and the second end surface 034 is D2. When the second connecting member 20 rotates 90 degrees relative to the front connecting member 10, the distance between the double-groove member 03 and the force F2 of the position Q2 to the spring 40 is T2, and the size of the double-groove member 03 along the length direction of the guide groove A is W2.

Since L2>L1, in the embodiment of the present application, the second connecting portion 21 is closer to the second end surface 302, that is, D1<D2. When the size of the guide member 30 along the length direction of the second guide groove 32 is constant, and when the second connecting member 20 and the abutting member rotate at a large angle with respect to the guide member, for example, when the second connecting member 20 rotates 90 degrees, the distance between the position Q1 and the force F1 of spring 40 in the embodiment of the present application is larger, that is, T1>T2, accordingly, F1*T1 in the embodiment of the present application forms the restoring torque of the second connecting member 20, which is greater than the restoring torque of F2*T2 forming the second connecting member 20 in the comparison embodiment. It should be understood that when the required restoring torque of the second connecting member 20 in the embodiments of the present application is close to or equal to the required restoring torque of the second connecting member 20 in the comparison embodiment, the size W1 of the guide member 30 in the embodiments of the present application along the length direction of the second guide groove 32 is smaller, that is, W1<W2.

It can be seen from the above that in the embodiments of the present application, the size H1 of the guide member 30 along the length direction of the first guide groove 31 and the size W1 along the length direction of the second guide groove 32 are smaller to reduce the size of the guide member 30, and accordingly the size of the spectacles hinge 100 is smaller.

According to the experimental test, the guide member 30 in the embodiments of the present application and the double-groove member 03 in the comparative technical solution are usually made of metal materials. Even if the metal materials with good strength and hardness, such as stainless steel, are selected, the distance L2 from the bottom surface 035 of the A guide groove of the double-groove member 03 to the front end surface 034 cannot be less than 0.5 mm, otherwise the double-groove member 03 will be deformed due to insufficient strength and cannot work normally. In the embodiment of the present application, the minimum value of the thickness L1 of the first sub-bottom 351 close to the end of the second guide groove 32 can be less than or equal to 0.3 mm, so that the hinge of the first connecting portion 11 with the second connecting portion 21 is closer to the second end surface 302.

In one embodiment, the first inclined surface 351 is all of the first divided surface 35, that is, the first divided surface 35 is the first inclined surface 351 as a whole. It can be understood that part of the first divided surface 35 is the first inclined surface 351.

In one embodiment, the second inclined surface 361 is all of the second divided surface 36, that is, the second divided surface 36 is the second inclined surface 361 as a whole. It can be understood that part of the second divided surface 36 is the first inclined surface 361.

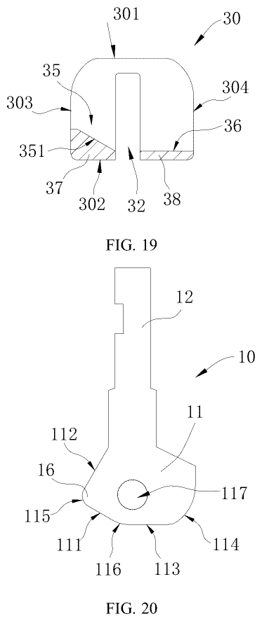

As shown in FIGS. 19 to 25. The differences between the spectacles hinge 100 in the embodiment and the spectacles hinge 100 in Embodiment 1 are as follows:

In the embodiment, the second divided surface 36 of the first guide groove 31 of the guide member 30 is a flat surface parallel to the second end surface 302, that is, the thicknesses of the second divided surface 38 are the same everywhere.

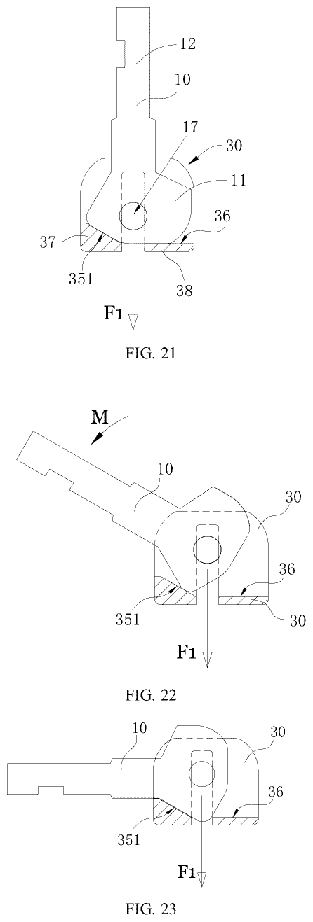

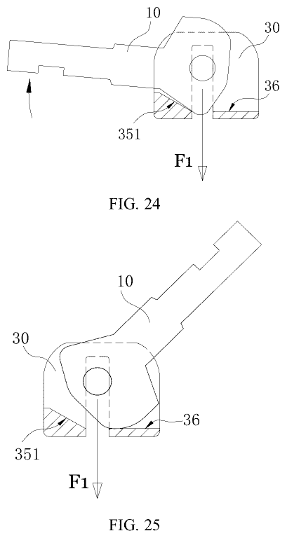

As shown in FIG. 21, the first connecting member 10 is in the open position, and the first connecting portion 11 is stably positioned in the open position by the first positioning surface 12 abutting against the first inclined surface 351, and the third positioning surface 113 abutting against the second divided surface 36; as shown in FIG. 23, the first connecting member 10 is in the closed position, and the first connecting member 10 is stably positioned in the closed position by the second positioning surface 112 abutting against the first inclined surface 351. When the first connecting member 10 needs to rotate from the open position shown in FIG. 21 to the closed position shown in FIG. 23, the situation is the same as that of in Embodiment 1, wherein the first smooth transition surface 115 of the convex portion 16 slides smoothly on the first inclined surface 351, without jamming. Moreover, when the first connecting member 10 is rotated about 55 degrees from the open position to the closed position as shown in FIG. 22, the first connecting member 10 can automatically rotate to the closed position as shown in FIG. 23 under the force of the spring 40 in the direction of arrow F1. When the spectacles hinge needs to rotate from the closed position as shown in FIG. 23 to the open position, for example, rotating 5 degrees from the initial position to the state as shown in FIG. 24, which can also be carried out smoothly under the action of external forces without jamming, which is the same as that described in the previous Embodiment 1. Further, the spectacles hinge can automatically return to the closed position under the force of spring 40 after rotating a certain angle. When the first connecting member 10 rotates to the excessive open position, as shown in FIG. 25, the guide surface 114 is abutted against the second divided surface 36, and the force of the spring 40 can drive the first connecting member 10 returning to the open position.

In another important aspect, in Embodiment 2 of the present application, since the first divided surface 35 is provided with the first inclined surface 351, the thickness of the part of the first sub-bottom 37 close to the first side surface 303 is larger to enhance the structural strength of the whole bottom of the first guide groove 31, the thickness of the first sub-bottom 37 close to the end of the second guide groove 32 is smaller, and the thickness of the second sub-bottom 38 is smaller accordingly, such that the hinge of the first connecting portion 11 with the second connecting portion 21 is closer to the second end surface 302, so as to serve as the pivot of the second connecting member 20, that is, the hinge of the first connecting portion 11 with the second connecting portion 21 is closer to the second end surface 302.

As shown in FIG. 34, the embodiment of the present application further provides an assembly of a spectacles temple and an endpiece, which includes the endpiece 60, the spectacles temple 70, and the spectacles hinge 100. The endpiece is the common name of the spectacles industry, which is an end piece of the lens frame on the two sides. In a pair of spectacles, one end of the endpiece is connected with the lens frame, or mounted on the lens frame, or integrated with the lens frame, and the other opposite end of the endpiece is connected with the spectacles hinge. In the embodiment, the spectacles hinge can be the spectacles hinge 100 described in the Embodiment 1 or 2. The fixing portion 12 of the spectacles hinge 100 is connected with the endpiece 60, and the abutting member 50 of the spectacles hinge 100 is connected with the spectacles temple 70 to realize the hinging of the spectacles temple 70 with the endpiece 60. The spectacles hinge 100 of the above embodiment uses the combination of the spectacles temple and the endpiece, which can realize the rotation of the spectacles temple 70 between the open state and the closed state, such that the spectacles temple 70 is automatically returned to the open state when the spectacles temple 70 is in the excessive open state, and the spectacles temple 70 can be automatically returned the alignment position when it rotates in the up-and-down direction. In addition, the size of the spectacles hinge 100 can be made smaller, and the size and weight of the corresponding spectacles frame can be made smaller to improve the wearing experience of the user. It can be understood that the abutting member 50 of the spectacles hinge 100 can also be connected with the endpiece 60, and the fixing portion 12 of the spectacles hinge 100 can be connected with the spectacles temple 70 to realize the hinging between the spectacles temple 70 and the endpiece 60.

In one embodiment, the endpiece 60 is provided with a receiving hole (not shown), the fixing portion 12 can be inserted into the receiving hole to connect with the endpiece 60.

In one embodiment, as shown in FIG. 34. The spectacles hinge 100 further includes an end element 80, which includes an end platform 81 and a fixing sleeve 82. The fixing sleeve 82 is connected with the end platform 81. The end element 80 is provided with an assembly hole 801 for assembling the fixing portion 12 therein, and the fixing sleeve 82 is matched with the receiving hole on the endpiece 60 to connect the fixing portion 12 with the endpiece 60. It is understood that the fixing portion 12 can also be directly connected with the endpiece 60.

In one embodiment, the spectacles temple 70 is provided with an accommodating hole 71, the spring 40 and the supporting portion 22 are extended into the accommodating hole 71, so as to connect the abutting member 50 with the spectacles temple 70.

In one embodiment, as shown in FIG. 34. The abutting member 50 includes a supporting plate 51 and a connecting sleeve 52. The supporting surface 501 is located on the supporting plate 51, the connecting sleeve 52 is connected with the supporting plate 51, the through cavity 502 penetrates the supporting plate 51 and the connecting sleeve 52, the connecting sleeve 52 is connected with the supporting plate 51, the supporting plate 51 is abutted against the guide member 30, and the connecting sleeve 52 is matched with the accommodating hole 71 to realize the connection between the abutting member 50 and the spectacles temple 70. It is understood that the abutting member 50 can also be a part of the spectacles temple 70. It can be understood that the abutting member 50 can also be integrally formed with the spectacles temple 70.

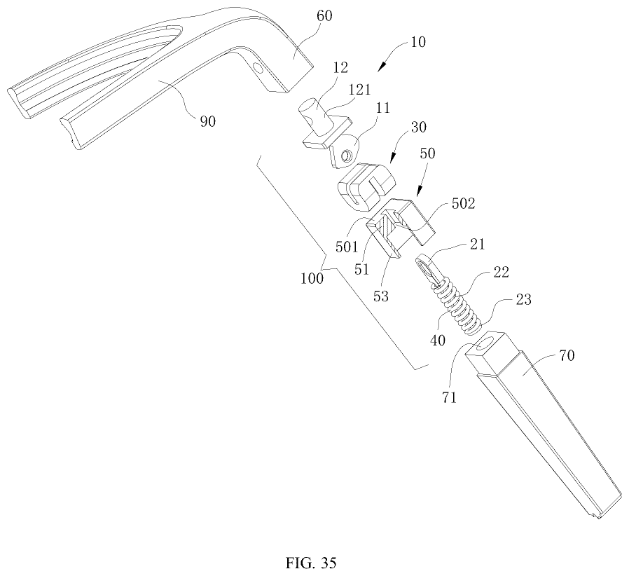

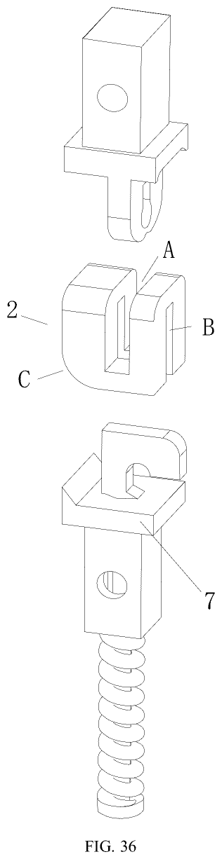

As shown in FIG. 35. The embodiment of the present application further provides a pair of spectacles, including a lens frame 90, spectacles temples 70 and spectacles hinges 100. The lens frame 90 includes the endpiece 60. In the embodiment, the fixing portion 12 of the spectacles hinge 100 is connected with the endpiece 60, and the abutting member 50 of the spectacles hinge 100 is connected with the spectacles temple 70 to realize the hinging between the spectacles temple 70 and the endpiece 60. The abutting member 50 includes the supporting plate 51 and the connecting frame 53, the supporting surface 501 is located on the supporting plate 51, the connecting frame 53 is connected with the supporting plate 51, the through cavity 502 penetrates the supporting plate 51, and the connecting frame 53 is sleeved on the spectacles temple 70 to connect with the spectacles temple 70, thus realizing the connection between the abutting member 50 and the spectacles temple 70. It can be understood that the abutting member 50 can also be set in other forms, as long as it is provide with the supporting surface 501, and provide with a through cavity for the second connecting portion 21 to extend out of the supporting surface 501, and can be connected with the spectacles temple 70. In this embodiment, the fixing portion 12 of the first connecting member 10 includes a mounting column 121, which is integrally formed with the first connecting portion 11 to facilitate producing and processing.

In one embodiment, the fixing portion 12 is integrally formed with the lens frame of a pair of spectacles, that is, the first connecting member 10 is integrally formed with the lens frame of a pair of spectacles. It is understood that the fixing portion 12 can also be integrally formed with the spectacles temples of a pair of spectacles.

The embodiment of the present application further provides a pair of spectacles, including the lens frame and the spectacles temple, and further includes the spectacles hinge as described in any of the above embodiments of the present application, which is used to hinge the spectacles temple to the lens frame. The spectacles hinge has the technical effect of the spectacles hinge in the above embodiment, which will not be repeated herein.

The above is only an optional embodiment of the present application and is not intended to limit the present application. Any modification, equivalent replacement and improvement made within the spirit and principles of the present application shall be included in the scope of protection of the present application.

1. A spectacles hinge, comprising:
a guide member, provided with a first end surface and a second end surface arranged to be opposite to each other, wherein the first end surface is provided with a first guide groove, the second end surface is provided with a second guide groove, the first guide groove is vertically intersected with the second guide groove, and the second guide groove divides a bottom surface of the first guide groove into a first divided surface and a second divided surface;
a first connecting member, comprising a first connecting portion and a fixing portion connected with the first connecting portion;
a second connecting member, comprising a second connecting portion, a supporting portion connected with the second connecting portion, and a stop portion arranged on the supporting portion;
an abutting member, provided with a supporting surface for abutting against the guide member, wherein the abutting member is provided with a through cavity configured to be movably penetrated by the second connecting portion; and
a spring, provided with two ends being elastically abutted against the abutting member and the stop portion respectively;
wherein the first connecting portion and the second connecting portion are hinged in the guide member and are mutually rotating pivots; the first connecting portion is able to pivot along the first guide groove and the second connecting portion is able to pivot along the second guide groove;
wherein the first divided surface comprises a first inclined surface, and the first inclined surface is inclined and extended from an end of the first inclined surface away from the second divided surface to an end of the first inclined surface close to the second divided surface, in a direction towards the second end surface; and
wherein the first connecting portion is provided with:
a first positioning surface, configured to be adapted to support the first inclined surface to position the first connecting portion at an open position;
a second positioning surface, configured to be adapted to support the first inclined surface to position the first connecting portion at a closed position; and
a third positioning surface, configured to be abutted against the second divided surface when the first connecting portion is positioned at the open position.

2. The spectacles hinge according to claim 1, wherein the first connecting portion is provided with a guide surface configured to support the second divided surface when the spectacles hinge is excessively opened, to guide the first connecting portion to return to the open position.

3. The spectacles hinge according to claim 2, wherein the guide surface is a circular arc surface, or the guide surface is an arc surface smoothly connected by a plurality of circular arc surfaces.

4. The spectacles hinge according to claim 1, wherein a first smooth transition surface is arranged between the first positioning surface and the second positioning surface.

5. The spectacles hinge according to claim 1, wherein the first inclined surface is a flat surface or a curved surface, or a combination of a flat surface and a curved surface.

6. The spectacles hinge according to claim 1, wherein the second divided surface comprises a second inclined surface, and the second inclined surface is inclined and extended from an end of the second inclined surface away from the first divided surface to an end the second inclined surface close to the first divided surface in a direction towards the second end surface.

7. The spectacles hinge according to claim 6, wherein an inclination of the first inclined surface is equal to that of the second inclined surface.

8. The spectacles hinge according to claim 1, wherein the second divided surface is parallel to the second end surface.

9. The spectacles hinge according to claim 1, wherein the first positioning surface is a flat surface or a curved surface, and the second positioning surface is a flat surface or a curved surface.

10. The spectacles hinge according to claim 1, wherein a second smooth transition surface is arranged between the first positioning surface and the third positioning surface.

11. The spectacles hinge according to claim 1, wherein the third positioning surface is a circular arc surface, or the third positioning surface is an arc surface smoothly connected by a plurality of circular arc surfaces.

12. The spectacles hinge according to claim 1, wherein the second end surface is a flat surface, and two opposite ends of the guide member along a length direction of the second guide groove are respectively provided with a guide arc surface connected to the second end surface.

13. The spectacles hinge according to claim 192, wherein two guide arc surfaces are symmetrically arranged relative to the first guide groove.

14. The spectacles hinge according to claim 1, wherein the abutting member comprises a supporting plate and a connecting sleeve, the supporting plate is configured to be abutted against the guide member, the connecting sleeve is configured to be connected with the supporting plate, and the connecting sleeve is configured for receiving in a receiving hole of one of a spectacles temple or an endpiece.

15. The spectacles hinge according to claim 14, wherein the abutting member comprises a supporting plate and a connecting frame, the supporting plate is configured to be abutted against the guide member, the connecting frame is configured to be connected with the supporting plate, and the connecting frame is configured to be sleeved on the spectacles temple or on the endpiece.

16. An assembly of a spectacles temple and an endpiece, comprising the spectacles temple and the endpiece, wherein further comprises a spectacles hinge, comprising:
a guide member, provided with a first end surface and a second end surface arranged to be opposite to each other, wherein the first end surface is provided with a first guide groove, the second end surface is provided with a second guide groove, the first guide groove is vertically intersected with the second guide groove, and the second guide groove divides a bottom surface of the first guide groove into a first divided surface and a second divided surface;
a first connecting member, comprising a first connecting portion and a fixing portion connected with the first connecting portion;
a second connecting member, comprising a second connecting portion, a supporting portion connected with the second connecting portion, and a stop portion arranged on the supporting portion;
an abutting member, provided with a supporting surface for abutting against the guide member, wherein the abutting member is provided with a through cavity configured to be movably penetrated by the second connecting portion; and
a spring, provided with two ends being elastically abutted against the abutting member and the stop portion respectively;
wherein the first connecting portion and the second connecting portion are hinged in the guide member and are mutually rotating pivots; the first connecting portion is able to pivot along the first guide groove and the second connecting portion is able to pivot along the second guide groove;
wherein the first divided surface comprises a first inclined surface, and the first inclined surface is inclined and extended from an end of the first inclined surface away from the second divided surface to an end of the first inclined surface close to the second divided surface in a direction towards the second end surface; and
wherein the first connecting portion is provided with:
a first positioning surface, configured to be adapted to support the first inclined surface to position the first connecting portion at an open position;
a second positioning surface, configured to be adapted to support the first inclined surface to position the first connecting portion at a closed position; and
a third positioning surface, configured to be abutted against the second divided surface when the first connecting portion is positioned at the open position; and
the fixing portion is connected with one of the spectacles temple and the endpiece, and the abutting member is connected with the other one of the spectacles temple and the endpiece.

17. The assembly of a spectacles temple and an endpiece according to claim 16, wherein the fixing portion and the endpiece are formed as an integral structure, or the fixing portion and the spectacles temple are formed an integral structure.

18. A pair of spectacles, comprising a lens frame and spectacles temples, wherein further comprises a spectacles hinge to hinge the spectacles temples to the lens frame; wherein the spectacles hinge comprises:
a guide member, provided with a first end surface and a second end surface arranged to be opposite to each other, wherein the first end surface is provided with a first guide groove, the second end surface is provided with a second guide groove, the first guide groove is vertically intersected with the second guide groove, and the second guide groove divides a bottom surface of the first guide groove into a first divided surface and a second divided surface;
a first connecting member, comprising a first connecting portion and a fixing portion connected with the first connecting portion;
a second connecting member, comprising a second connecting portion, a supporting portion connected with the second connecting portion, and a stop portion arranged on the supporting portion;
an abutting member, provided with a supporting surface for abutting against the guide member, wherein the abutting member is provided with a through cavity configured to be movably penetrated by the second connecting portion; and
a spring, provided with two ends being elastically abutted against the abutting member and the stop portion respectively;
wherein the first connecting portion and the second connecting portion are hinged in the guide member and are mutually rotating pivots; the first connecting portion is able to pivot along the first guide groove and the second connecting portion is able to pivot along the second guide groove;
wherein the first divided surface comprises a first inclined surface, and the first inclined surface is inclined and extended from an end of the first inclined surface away from the second divided surface to an end of the first inclined surface close to the second divided surface in a direction towards the second end surface; and
wherein the first connecting portion is provided with:
a first positioning surface, configured to be adapted to support the first inclined surface to position the first connecting portion at an open position;
a second positioning surface, configured to be adapted to support the first inclined surface to position the first connecting portion at a closed position; and
a third positioning surface, configured to be abutted against the second divided surface when the first connecting portion is positioned at the open position.

19. The pair of spectacles according to claim 18, wherein the fixing portion and the lens frame are integrally formed, or the fixing portion and the spectacles temples are integrally formed.
